(19) United States
(12) Patent Application Publication
(10) Pub. No.: US 2016/0141847 A1
(43) Pub. Date: May 19, 2016

(54) Remote tool device

(71) Applicants: Kenny Kenny, Quinlan, TX (US); Steven Stone, Quinlan, TX (US)

(72) Inventors: Kenny Kenny, Quinlan, TX (US); Steven Stone, Quinlan, TX (US)

(21) Appl. No.: 14/542,553

(22) Filed: Nov. 15, 2014

(51) Int. Cl. H02G 1/02; B25G 1/12; B25F 5/02

(52) U.S. Cl. CPC H02G 1/02; B25F 5/02; B25G 1/12

(57) ABSTRACT

A remote tool device for remotely operating a tool and may include an isolation pole for insulating the remote tool device from the user, a pair of opposing contacts to make an electrical contact in a first position and a second position and a housing to house the contacts. The remote tool device may include a pivoting device to pivot between the first position and the second position.

### FIELD OF THE INVENTION

The present invention relates to a tool device and more particularly to a tool device which may be operated remotely.

### BACKGROUND

The need to maintain high voltage transmission and distribution equipment, apparatuses and lines is well known in the art. It is known that in many applications, the devices must be serviced and/or maintained while energized. In many instances, above certain thresholds (in some instances over 25 kV in other instances over 500 kV), it is common to utilize insulated poles (often termed a “hot stick”) to insulate a lineman from the high voltage. One such insulated pole is shown in U.S. Pat. No. 2,316,204 issued to Williams. It has been known to adapt a hand tool, such as a ratchet, to the end of such an insulated pole, either directly or through a swivel mechanism (often termed a “jack ratchet”). In prior applications, such as is shown in U.S. Pat. No. 4,326,316, issued to Dolenti, hydraulically powered tools have been provided and coupled to the end of an insulated pole.

Problematically, in each such situation, there are limitations. First, with hand tools, there are limitations as to the amount of torque or force that can be applied, and also difficulty with respect to having the strength to articulate the tools through a desired articulation. With respect to the hydraulically powered tools, there have been other problems. First, the tools themselves are quite heavy. In turn, it is difficult for a lineman to properly control the tool at the opposite end of the insulated pole. In addition, such hydraulic powered tools require a remotely positioned hydraulic power source (and thus, hydraulic lines from the power source to the hydraulic powered tool itself). For these reasons, the hydraulically powered tools have not been well received. One such tool is described in US patent application 20140102739.

In some cases, it is necessary to perform tasks that are unrelated to the operation of the electrical equipment. For example, trees have a tendency to grow and pose a danger to the electrical equipment in the event of a storm or high winds. Consequently, these trees and other work related items may be more conveniently performed from a ground location rather than climbing a pole or operating a bucket.

### SUMMARY

A remote tool device for remotely operating a tool and may include an isolation pole for insulating the remote tool device from the user, a pair of opposing contacts to make an electrical contact in a first position and a second position and a housing to house the contacts;

The remote tool device may include a pivoting device to pivot between the first position and the second position.

The pivoting device may include an L-shaped arm.

The pivoting device may include a pivoting sleeve.

The housing may include a biasing device to bias the pivoting device.

The housing may include a motor to drive the tool.

The motor may be electrically connected to the pair of opposing contacts.

The motor may be electrically connected to a pair of opposing contacts connected in parallel.

The biasing device may be a spring.

The pivoting device may include a central arm.

The pivoting device may include a pivoting platform.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional/side view of the remote tool device of the present invention;

FIG. 2 illustrates an alternate portion in a perspective view of the remote tool device of the present invention;

FIG. 3 illustrates another cross-sectional view of the remote tool device of the present invention;

FIG. 4 illustrates the remote tool device of the present invention;

FIG. 5 illustrates the operation of the remote tool device of the present invention;

FIG. 6 illustrates an electrical circuit of the present invention.

### DETAILED DESCRIPTION

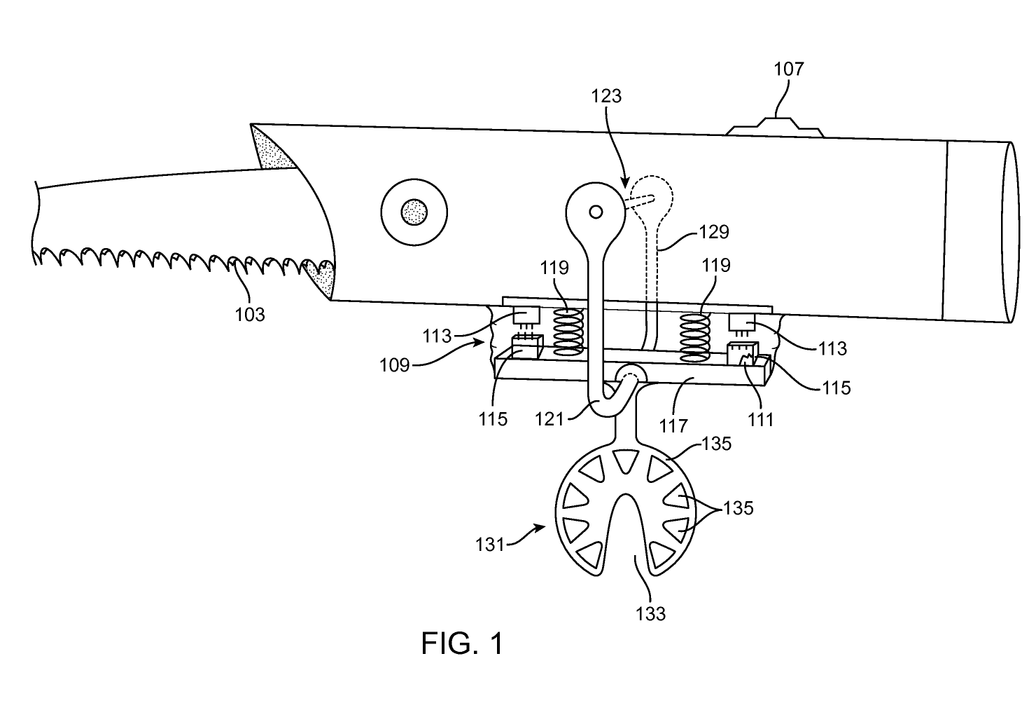

FIG. 1 illustrates a cross-sectional view of the remote tool device 100 of the present invention and illustrates a housing 101 to house the motor (not shown) to drive a tool 103 which may be a saw blade, sawzall clippers, drill, circular saw, impact tool, tree loppers, wire cutters vine pullers or other appropriate tool. The motor may be connected to a switch 107 which may turn on and turn off the motor and may be operated by the user of the remote tool device 100. The motor may additionally be controlled by a pair of opposing contact switches 109, 111. The opposing contact switches 109, 111 may be electrically connected in parallel in order that only one of the contact switches 109, 111 are closed, and the power flows through the closed contact switches 109, 111 to the motor in order to operate the tool 103. Each of the contact switches 109, 111 may include a first contact switch 113 and a second contact switch 115. Electrical connection is made when the first contact switch 113 mates with the second contact switch 115. The first contact switch 113 may be positioned on the housing 101, and the second contact switch 115 may be positioned on a pivoting platform 117 which may pivot between a first position where the first contact switch 113 and the second contact switch 115 of the contact switch 109 mate and a second position where the first contact switch 113 and the second contact switch 115 of the contact switch 111 mate.

The first contact switch 113 may be mounted on the housing 101 and the second contact switch 115 may be mounted on the platform 117. Additionally, a pair of opposing biasing devices 119 which may be springs may be connected between the housing 101 and the platform 117. The biasing devices 119 may keep the distance between the housing 101 and the platform 117 equidistant when no forces being applied to the remote tool device 100 and returns the housing 101 and the platform 117 to a position being equidistant when the force is removed from the remote tool device 100.

A pair of opposed L-shaped arms 121 connect the housing 101 and the platform 117. A pivoting sleeve 123 is connected to the housing 101, and a pivoting shaft 125 extends through the pivoting sleeve 123 and may be connected to the end of the L-shaped arms 121. The pivoting sleeve 123 may pivot or rotate either forward or backwards on the pivoting shaft 125 allowing the platform 117 to pivot either forwards or backwards (up/down) and to allow the first contact switch 113 to make or break a contact with the second contact switch 115.

FIG. 1 additionally illustrates a connecting disk 131 which may be noncontinuous in order to connect to a isolation stick (hot stick) which may be a relatively long shaft formed from material which has not conduct electricity in order to isolate the remote tool device 100 with the user from electrical shock which may be obtained from inadvertently touching hot electrical wires. The disk 131 may have a channel 133 and apertures 135 to facilitate connection with the isolation stick.

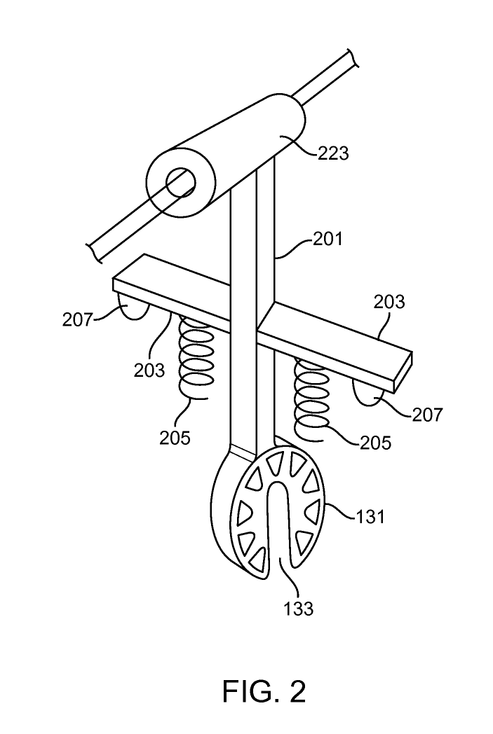

FIG. 2 illustrates an additional connection device to connect to the housing 101. The connection device may include a central arm 201 which may connect to a disc 131 and may connect to a pivoting sleeve 223. A pair of horizontal arms 203 may extend from the central arm 201 in opposing directions. A biasing device 205 and contact switches 207 may extend from the horizontal arms 203.

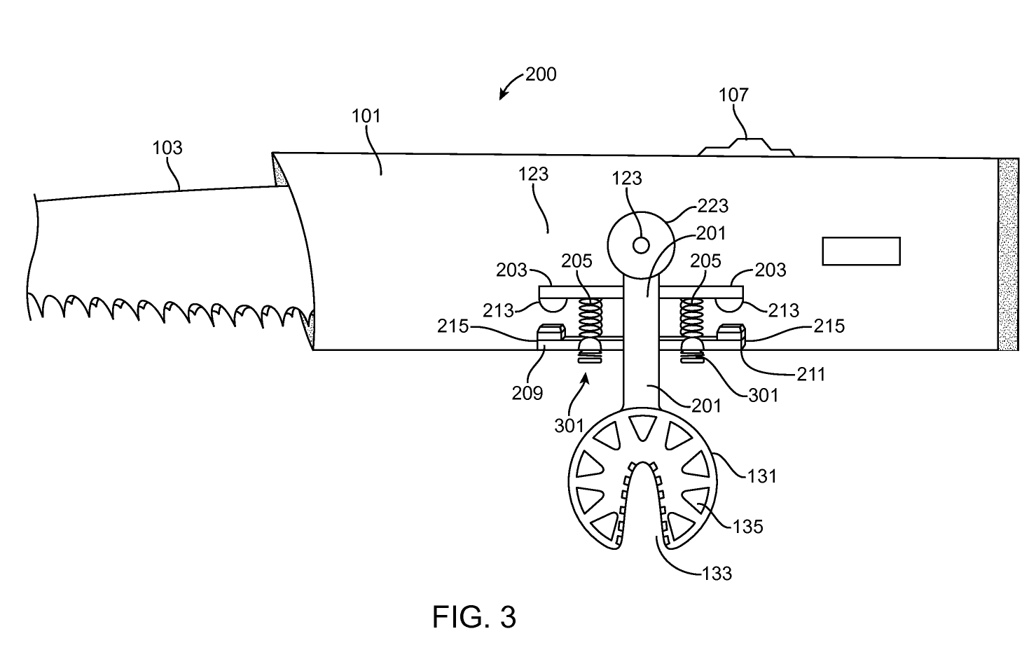

FIG. 3 illustrates a cross-sectional view of the remote tool device 200 of the present invention and illustrates a housing 101 to house the motor (not shown) to drive a tool 103 which may be a saw blade, clippers, drill, or other appropriate tool. The motor may be connected to a switch 107 which may turn on and turn off the motor and may be operated by the user of the remote tool device 200. The motor may additionally be controlled by a pair of opposing contact switches 209, 211. The opposing contact switches 209, 211 may be electrically connected in parallel in order that only one of the contact switches 209, 211 are closed, and the power flows through the closed contact switches 209, 211 to the motor in order to operate the tool 103. Each of the contact switches 209, 211 may include a first contact switch 213 and a second contact switch 215. Electrical connection is made when the first contact switch 213 mates with the second contact switch 215. The first contact switch 213 may be positioned on the horizontal arms 203, and the second contact switch 115 may be positioned on the housing 101 which may pivot between a first position where the first contact switch 213 and the second contact switch 215 of the contact switch 209 mate and a second position where the first contact switch 213 and the second contact switch 215 of the contact switch 211 mate.

The first contact switch 213 may be mounted on the horizontal arms 203 and the second contact switch 215 may be mounted on the housing 101. Additionally, a pair of opposing biasing devices 205 which may be springs may be connected between the housing 101 and the arms 203. The biasing devices 203 may keep the distance between the housing 101 and the arms 203 equidistant when no forces being applied to the remote tool device 100 and the biasing devices 205 return the housing 101 and the arms 203 to a neutral position being substantially equidistant when the force is removed from the remote tool device 100.

FIG. 3 illustrates an additional connection device to connect to the housing 101. The connection device may include a central arm 201 which may connect to a disc 131 and may connect to a pivoting sleeve 223. A pair of horizontal arms 203 may extend from the central arm 201 in opposing directions. A biasing device 205 and contact switches 207 may extend from the horizontal arms 203.

FIG. 3 additionally illustrates a connecting disk 131 which may be noncontinuous in order to connect to a isolation stick (hot stick) which may be a relatively long shaft formed from material which does not conduct electricity in order to isolate the remote tool device 100 with the user from electrical shock which may be obtained from inadvertently touching hot electrical wires. The disk 131 may have a channel 133 and apertures 135 to facilitate connection with the isolation stick.

FIG. 3 additionally illustrates a pair of opposing tensioning devices 301 which may be a pair of set screws or other appropriate device in order to adjust the tension placed on the biasing devices 205

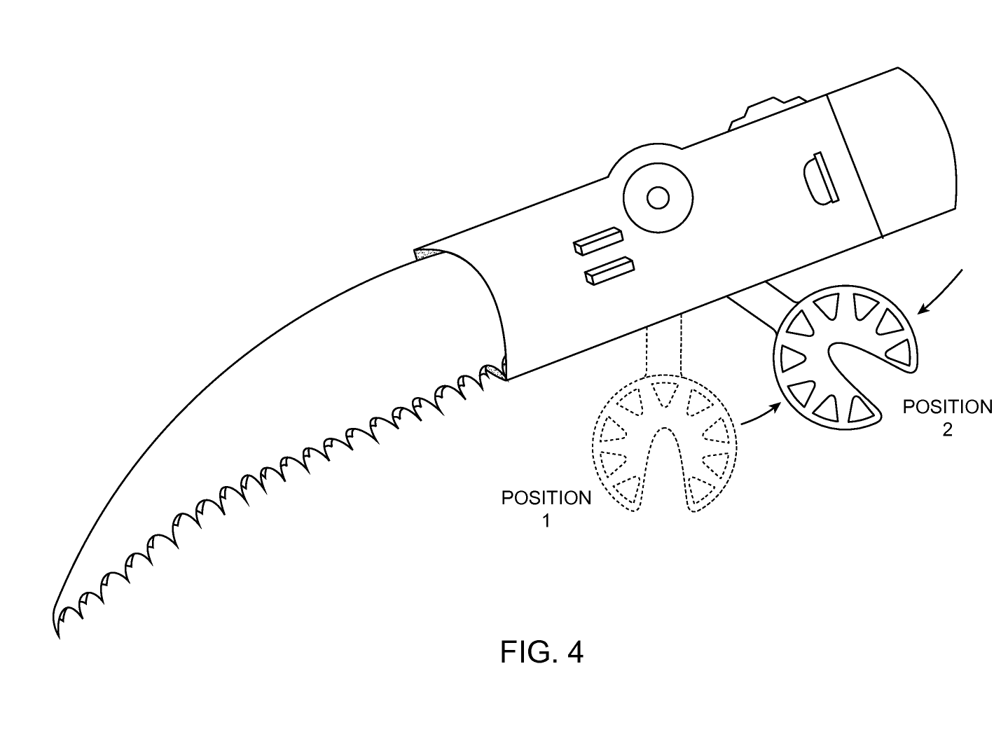

FIG. 4 illustrates the disk 131 and the central arm 201 moving between the first position and a second position. Both the first position and a second position will activate the tool 103, but the central arm 201 positioned in a neutral position as illustrated in FIG. 3 may inactivate the tool 103.

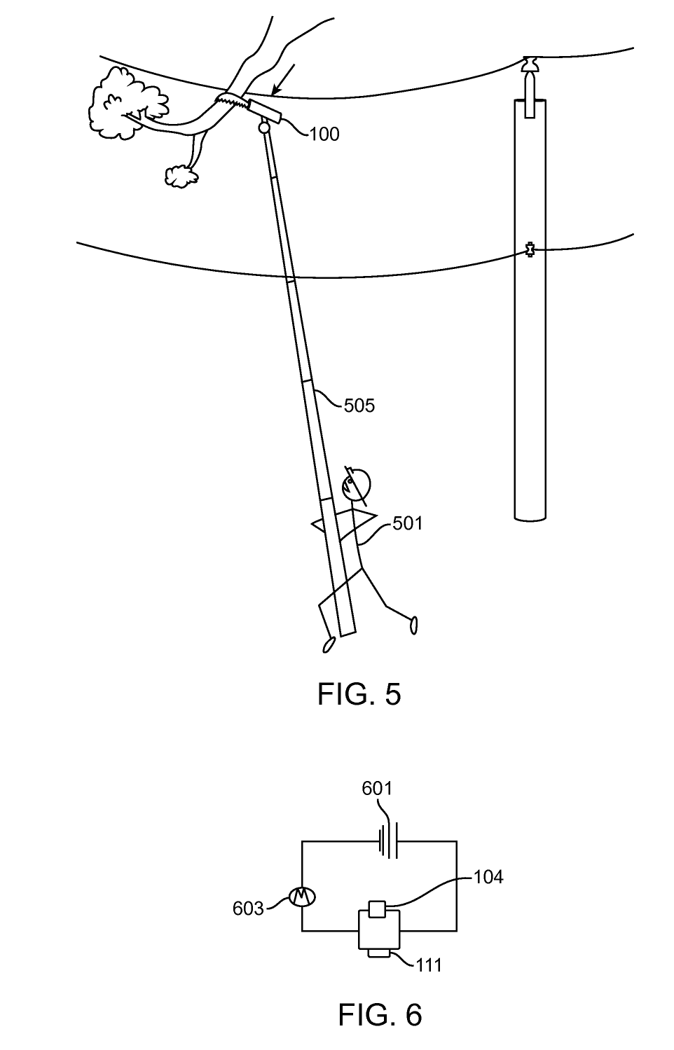

FIG. 5 illustrates the user 501 operating the remote tool device 100 on a tree branch adjacent to electric wires through an isolation pole 502 (hot stick) which may be a telescoping pole in order to adjust the height of the remote tool device 100 and which may be insulating in order to provide safety for the user 501.

FIG. 6 illustrates a circuit diagram of the present invention which includes a battery 601 which may be connected to a motor 603 to drive the tool 103 (not shown) and which may be connected to contact switches 109, 111 which may be connected in parallel. The contact switches 109, 111 may be connected to the motor 603.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A remote tool device for remotely operating a tool, comprising:
an isolation pole for insulating the remote tool device from the user;
a pair of opposing contacts to make an electrical contact in a first position and a second position;
a housing to house the contacts;
wherein the remote tool device includes a pivoting device to pivot between the first position and the second position.

2) A remote tool device for remotely operating a tool as in claim 1, wherein the pivoting device includes an L-shaped arm.

3) A remote tool device for remotely operating a tool as in claim 1, wherein the pivoting device includes a pivoting sleeve.

4) A remote tool device for remotely operating a tool as in claim 1, wherein the housing includes a biasing device to bias the pivoting device.

5) A remote tool device for remotely operating a tool as in claim 1, wherein the housing includes a motor to drive the tool.

6) A remote tool device for remotely operating a tool as in claim 5, wherein the motor is electrically connected to the pair of opposing contacts.

7) A remote tool device for remotely operating a tool as in claim 5, wherein the motor is electrically connected to a pair of opposing contacts connected in parallel.

8) A remote tool device for remotely operating a tool as in claim 4, wherein the biasing device is a spring.

9) A remote tool device for remotely operating a tool as in claim 1, wherein the pivoting device includes a central arm.

10) A remote tool device for remotely operating a tool as in claim 1, wherein the pivoting device includes a pivoting platform.
